(19) United States
(12) Patent Application Publication
(10) Pub. No.: US 2026/0166964 A1
(43) Pub. Date: Jun. 18, 2026

(54) HEAT PUMP SYSTEM FOR VEHICLE

(71) Applicant: Hanon Systems, Daejeon (KR)

(72) Inventors: Dae Woong LEE, Daejeon (KR); Min Sung KIM, Daejeon (KR)

(73) Assignee: Hanon Systems, Daejeon (KR)

(21) Appl. No.: 19/121,747

(22) PCT Filed: Jan. 15, 2024
(86) PCT No.: PCT/KR2024/000678

§ 371 Date: Feb. 25, 2026

(30) Foreign Application Priority Data
Feb. 24, 2023 (KR) 10-2023-0025210

(51) Int. Cl. B60H 1/32

(52) U.S. Cl. CPC B60H 1/32284

(57) ABSTRACT

A heat pump system for a vehicle, being capable of heating the indoor space under a low-temperature environment without driving an engine, improving fuel efficiency, reducing the emission of carbon dioxide, and moreover, improving comfortability for passengers is disclosed. The heat pump system includes: a refrigerant line which cools down or heats the indoor space of the vehicle by circulating a refrigerant discharged from a compressor; a first coolant line which circulates through a heater core arranged in an engine and an air-conditioning case; and a second coolant line which circulates through electric components and an electric component radiator. In addition, a chiller which thermally exchanges electronic heat from the second coolant line with a refrigerant is provided, and an intermediate heat exchanger which thermally exchanges heat with an expanded refrigerant in an upstream refrigerant line of the chiller and cools down the refrigerant passing therethrough is provided.

### TECHNICAL FIELD

The present invention relates to a heat pump system, and more particularly, to a heat pump system installed in a hybrid vehicle that enables indoor heating in a low-temperature environment without operating the engine.

### BACKGROUND ART

In general, an air conditioner for a vehicle includes a cooling system for cooling the indoor space of the vehicle, and a heating system for heating the indoor space of the vehicle. The cooling system, at an indoor heat exchanger side of a refrigerant cycle, converts the air passing the outside of the indoor heat exchanger into cold air by exchanging heat between the air and a refrigerant flowing inside an evaporator to cool the indoor space of the vehicle. Moreover, the heating system, at a heater core side of a cooling water cycle, converts the air passing the outside of the heater core into warm air by exchanging heat between the air and cooling water flowing inside the heater core to heat the indoor space of the vehicle.

In the case of electric vehicles, a heat pump system which reverses the vapor compression cycle used for cooling is used. However, since such systems focus on modules for the distribution and supply of low-temperature coolant to improve driving range based on electric component waste heat, it is difficult to use the heat pump system in extremely low outdoor temperatures. As a result, the heat pump system must perform heating in parallel with a high-capacity PTC heater.

Referring to FIG. 1, a conventional heat pump system installed in a hybrid electric vehicle (HEV) includes a compressor 8, an outdoor heat exchanger 6, an expansion valve 5, and an evaporator 3. Additionally, an accumulator 9 is provided upstream of the compressor 8 in a refrigerant flow direction. High-temperature, high-pressure refrigerant discharged from the compressor 8 sequentially passes through the outdoor heat exchanger 6, the expansion valve 5, the evaporator 3, and the accumulator 9 and circulates to the compressor 8.

Inside the air-conditioning case 1, the evaporator 3 and a heater core 4 are arranged sequentially in an air flow direction. The evaporator 3 exchanges heat with the air passing through the evaporator, and the heater core 4 exchanges heat with the air passing through the heater core, thereby heating the air. A temperature door 2 is installed between the evaporator 3 and the heater core 4 to regulate air temperature. Additionally, a PTC heater 7 may be installed downstream of the heater core 4 in the air flow direction.

Meanwhile, a coolant line which passes through an engine 13 flows through a water pump 16 and a reservoir tank 15, and then, passes through a radiator 14. Waste heat of the engine 13 is cooled by heat exchange with the outdoor air in the radiator 14. Additionally, a portion of the coolant line that passes through the engine 13 passes through a water pump 11 and the heater core 4, and then circulates back to the engine 13. The high-temperature coolant which has cooled down the engine 13 in the heater core 4 exchanges heat with the air discharged into the indoor space, thereby performing heating.

Furthermore, with a reservoir tank 18, a water pump 19, and a low-temperature radiator 20 are provided in another coolant line passing through an electric component 17 such as a PE module, so that coolant is circulated. The heat pump system for the vehicle installed in the hybrid vehicle configured in this manner performs heating by operating the engine 13 to heat the coolant, and performs cooling through the vapor compression cooling cycle using the compressor 8.

The conventional heat pump system installed in a hybrid vehicle operates the engine to heat the coolant for heating in the winter. So, such a conventional heat pump system requires continuous engine operation, leading to poor fuel efficiency in low-temperature conditions and increased carbon dioxide emissions. Additionally, there is a significant time delay before the coolant is heated and supplied to the heater core, reducing the comfort of passengers. Moreover, fuel efficiency tests conducted under the fuel efficiency evaluation mode have shown that, compared to normal temperatures, fuel efficiency decreases by 7% at −7° C., and when the air conditioning system is activated, fuel efficiency is further reduced by up to 32%.

### DISCLOSURE

### Technical Problem

Accordingly, the present invention has been made in view of the above-mentioned problems occurring in the related art, and it is an object of the present invention to provide a heat pump system for a vehicle, which can heat the indoor space under a low-temperature environment without driving an engine, improve fuel efficiency, reduce the emission of carbon dioxide, and improve the comfort of passengers.

### Technical Solution

To accomplish the above-mentioned objects, according to the present invention, there is provided a heat pump system for a vehicle including: a refrigerant line which circulates refrigerant discharged from a compressor to cool or heat the indoor space of the vehicle; a first coolant line which circulates an engine and a heater core arranged inside an air-conditioning case; and a second coolant line which circulates electric components and an electric component radiator, wherein a chiller is provided to exchange heat between the waste heat of the second coolant line and the refrigerant, and wherein an intermediate heat exchanger is provided in an upstream refrigerant line of the chiller to exchange heat with the expanded refrigerant, cooling the refrigerant passing through the intermediate heat exchanger.

An outdoor heat exchanger is provided in a downstream refrigerant line of the compressor to exchange heat between the refrigerant and outdoor air, and the intermediate heat exchanger is arranged between the outdoor heat exchanger and the chiller.

A branch line which branches from an upstream refrigerant line of the intermediate heat exchanger and merges into the downstream side thereof is provided, the intermediate heat exchanger exchanges heat between the refrigerant in the branch line and the refrigerant in the refrigerant line, and an expansion part for expanding the refrigerant is provided in the upstream branch line of the intermediate heat exchanger.

The compressor, an indoor heat exchanger arranged inside the air-conditioning case, the outdoor heat exchanger, the intermediate heat exchanger, and the chiller are sequentially provided in the refrigerant line. An evaporator line branches from the refrigerant line between the intermediate heat exchanger and the chiller, and an evaporator arranged inside the air-conditioning case is provided in the evaporator line.

A direction changing valve is provided at a branching point between the refrigerant line and the evaporator line to selectively direct the refrigerant, which has passed through the intermediate heat exchanger, to either the chiller or the evaporator.

The heat pump system further includes: a first expansion valve provided between the indoor heat exchanger and the outdoor heat exchanger to expand the refrigerant; and a second expansion valve provided in the evaporator line to expand the refrigerant.

The first expansion valve and the second expansion valve are configured to selectively allow the refrigerant to expand or bypass.

Heating is performed using engine heat of the first coolant line through the heater core when the engine is running, and heating is performed using condensation heat of the refrigerant in the refrigerant line when the engine is stopped, with the waste heat recovery of the chiller increased through the intermediate heat exchanger.

In a cooling mode, when the engine is operating, the refrigerant discharged from the compressor is primarily cooled in the outdoor heat exchanger, is secondarily cooled in the intermediate heat exchanger, bypasses the chiller, expands in the second expansion valve to cool the air flowing into the indoor space in the evaporator, and circulates back to the compressor. The coolant in the first coolant line is cooled in an engine radiator, and the coolant flow in the second coolant line is stopped.

In the cooling mode, when the engine is stopped, the refrigerant discharged from the compressor is primarily cooled in the outdoor heat exchanger, is secondarily cooled in the intermediate heat exchanger, bypasses the chiller, expands in the second expansion valve to cool the air flowing into the indoor space in the evaporator, and circulates back to the compressor. The coolant flow in the first coolant line is stopped, and the coolant in the second coolant line is cooled in the electric component radiator.

In a heating mode, when the engine is operating and the coolant temperature is below a reference value, the refrigerant discharged from the compressor heats the air flowing into the indoor space in the indoor heat exchanger, expands in the first expansion valve, passes through the outdoor heat exchanger, the intermediate heat exchanger, and the chiller, and then, circulates back to the compressor. The coolant in the first coolant line circulates through the heater core to heat the air flowing into the interior, and the coolant flow in the second coolant line is stopped.

In the heating mode, when the engine is operating and the coolant temperature exceeds the reference value, the refrigerant flow in the refrigerant line is stopped. The coolant in the first coolant line circulates through the heater core to heat the air flowing into the interior, and the coolant flow in the second coolant line is stopped.

In the heating mode, when the engine is stopped and the coolant temperature exceeds the reference value, the refrigerant discharged from the compressor heats the air flowing into the interior in the indoor heat exchanger, expands in the first expansion valve, and passes through the outdoor heat exchanger and the intermediate heat exchanger, and the refrigerant, which has been further cooled in the intermediate heat exchanger, exchanges heat with the coolant of the second coolant line in the chiller, and then circulates back to the compressor. The coolant in the first coolant line circulates through the heater core to heat the air flowing into the interior, and the coolant in the second coolant line is cooled in the chiller.

In the heating mode, when the engine is stopped and the coolant temperature is below the reference value, the refrigerant discharged from the compressor heats the air flowing into the interior in the indoor heat exchanger, expands in the first expansion valve, and passes through the outdoor heat exchanger and the intermediate heat exchanger, and the refrigerant, which has been further cooled in the intermediate heat exchanger, exchanges heat with the coolant of the second coolant line in the chiller, and then circulates back to the compressor. The coolant flow in the first coolant line is stopped, and the coolant in the second coolant line is cooled in the chiller.

In a dehumidification mode, when the engine is stopped and the coolant temperature exceeds the reference value, the refrigerant discharged from the compressor heats the air flowing into the interior in the indoor heat exchanger, expands in the first expansion valve, passes through the outdoor heat exchanger and the intermediate heat exchanger, and circulates back to the compressor in such a way that some of the refrigerant passes through the chiller and the rest of the refrigerant passes through the evaporator. The coolant in the first coolant line circulates through the heater core to heat the air flowing into the interior, and the coolant in the second coolant line is cooled in the chiller.

In the dehumidification mode, when the engine is stopped and the coolant temperature is below the reference value, the refrigerant discharged from the compressor heats the air flowing into the interior in the indoor heat exchanger, expands in the first expansion valve, passes through the outdoor heat exchanger and the intermediate heat exchanger, and circulates back to the compressor in such a way that some of the refrigerant passes through the chiller and the rest of the refrigerant passes through the evaporator. The coolant flow in the first coolant line is stopped, and the coolant in the second coolant line is cooled in the chiller.

In the dehumidification mode, when the engine is operating and the coolant temperature exceeds the reference value, the refrigerant discharged from the compressor is primarily cooled in the outdoor heat exchanger, is secondarily cooled in the intermediate heat exchanger, bypasses the chiller, expands in the second expansion valve to dehumidify the air flowing into the indoor space in the evaporator, and circulates back to the compressor. The coolant in the first coolant line circulates through the heater core to heat the air flowing into the interior, and the coolant in the second coolant line is cooled in the electric component radiator.

### Advantageous Effect

The heat pump system for a vehicle according to the present invention can heat the indoor space under a low-temperature environment without operating the engine, improve fuel efficiency, reduce the emission of carbon dioxide, and improve the comfort of passengers by applying the heat pump system to a hybrid vehicle. Moreover, the heat pump system is configured to work in conjunction with a conventional air conditioner using a heater core, and performs heating using coolant when the engine is operated, thus effectively heating the indoor space even in extremely low temperatures of −30° C.

Furthermore, in the cooling mode, the heat pump system utilizes the intermediate heat exchanger to further expand the refrigerant, thereby improving cooling efficiency and enhancing cooling performance. Additionally, in the heat pump mode, the heat pump system cools the hot refrigerant discharged from the compressor in the indoor heat exchanger and further cools in the intermediate heat exchanger to exchange heat between the cooled refrigerant and the waste heat of the electric component in the chiller, thereby facilitating efficient heat recovery and improving heat pump efficiency.

In addition, even when the engine is turned off during the operation in the heat pump mode, the heat pump system makes the most of the residual heat of the coolant due to the operation of the existing engine to perform heating. If the coolant temperature is below approximately 40° C. (which may vary depending on the outdoor temperature), the heat pump system can smoothly perform linking between heat sources without boundary layers due to the operation of the heat pump utilizing electric component waste heat, further enhancing the comfort of passengers.

### DESCRIPTION OF DRAWINGS

FIG. 1 illustrates a conventional heat pump system for a vehicle.

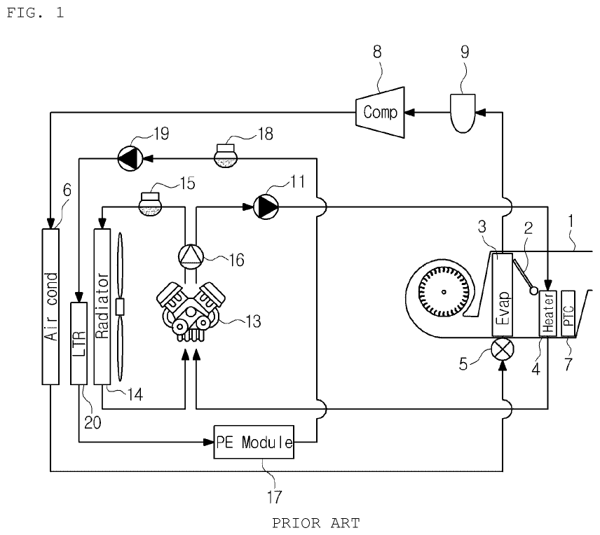

FIG. 2 illustrates a heat pump system for a vehicle according to an embodiment of the present invention.

FIG. 3 illustrates a cooling mode of the heat pump system for the vehicle according to an embodiment of the present invention when the engine is running.

FIG. 4 illustrates the cooling mode of the heat pump system for the vehicle according to an embodiment of the present invention when the engine is stopped.

FIG. 5 illustrates a heating mode of the heat pump system for the vehicle according to an embodiment of the present invention when the engine is running and the coolant temperature is low.

FIG. 6 illustrates the heating mode of the heat pump system for the vehicle according to an embodiment of the present invention when the engine is running and the coolant temperature is high.

FIG. 7 illustrates the heating mode of the heat pump system for the vehicle according to an embodiment of the present invention when the engine is stopped and residual heat remains in the coolant.

FIG. 8 illustrates the heating mode of the heat pump system for the vehicle according to an embodiment of the present invention when the engine is stopped and the coolant temperature is low.

FIG. 9 illustrates a dehumidification mode of the heat pump system for the vehicle according to an embodiment of the present invention when the engine is stopped and residual heat remains in the coolant.

FIG. 10 illustrates the dehumidification mode of the heat pump system for the vehicle according to an embodiment of the present invention when the engine is stopped and the coolant temperature is low.

FIG. 11 illustrates the dehumidification mode of the heat pump system for the vehicle according to an embodiment of the present invention when the engine is running and the coolant temperature is high.

### MODE FOR INVENTION

Hereinafter, a technical configuration of a heat pump system for a vehicle will be described in detail with reference to the accompanying drawings.

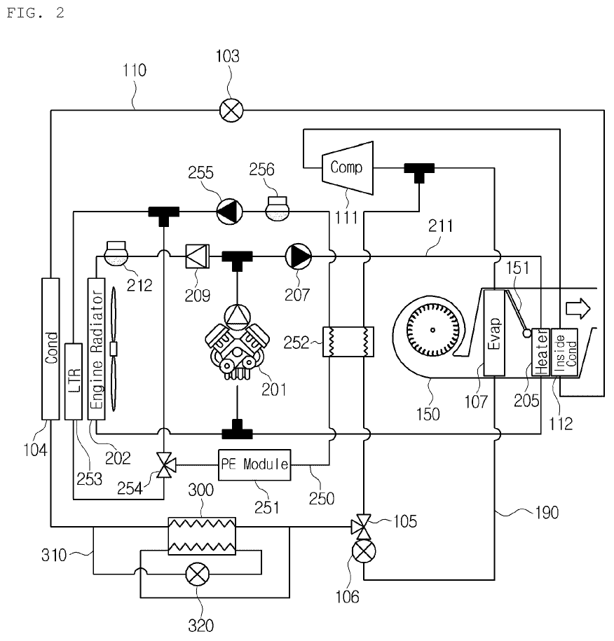

Referring to FIG. 2, a heat pump system for a vehicle according to an embodiment of the present invention is installed in a hybrid electric vehicle (HEV) equipped with an engine 201 and electric components 251. The heat pump system for the vehicle includes a refrigerant line 110, a first coolant line 211, and a second coolant line 250. In this case, the electric components 251 include a power electric module (PE module), and so on.

The refrigerant line 110 circulates the refrigerant discharged from a compressor 111 to cool or heat the indoor space of the vehicle. The compressor 111, an indoor heat exchanger 112, a first expansion valve 103, an outdoor heat exchanger 104, an intermediate heat exchanger 300, a direction changing valve 105, and a chiller 252 are arranged sequentially in the refrigerant line 110. The indoor heat exchanger 112 is installed inside the air-conditioning case 150 and performs heat exchange between the refrigerant and the air to heat the indoor space of the vehicle.

The compressor 111 compresses and discharges the refrigerant, and an accumulator is provided upstream of the compressor 111 in a refrigerant flow direction. The first expansion valve 103 is positioned between the indoor heat exchanger 112 and the outdoor heat exchanger 104, selectively allowing the refrigerant to expand or bypass. The first expansion valve 103 is an electronic expansion valve (EXV) that expands the refrigerant while controlling the refrigerant flow rate.

That is, in a cooling mode, the first expansion valve 103 allows the refrigerant to pass through without expansion, and in a heating mode, expands the refrigerant. As described above, the first expansion valve 103 selectively performs the refrigerant expansion function and the refrigerant bypass function. Meanwhile, the outdoor heat exchanger 104 is arranged outside the air-conditioning case 150 to exchange heat between the refrigerant and the outdoor air. The outdoor heat exchanger 104 is installed at the front of the vehicle to cool the refrigerant by driving wind. That is, the outdoor heat exchanger 104 is arranged in a downstream refrigerant line of the compressor 111, exchanging heat between the refrigerant and the outdoor air.

The intermediate heat exchanger 300 is provided in an upstream refrigerant line of the chiller 252 and exchanges heat with the expanded refrigerant to cool the refrigerant passing through the intermediate heat exchanger. The refrigerant line 110 includes a branch line 310. The branch line 310 is a passage of refrigerant that branches from the upstream refrigerant line 110 of the intermediate heat exchanger 300 and merges into the downstream side of the intermediate heat exchanger 300. The intermediate heat exchanger 300 exchanges heat between the refrigerant in the branch line 310 and the refrigerant in the refrigerant line 110.

Additionally, an evaporator line 190 branches from the refrigerant line 110 between the intermediate heat exchanger 300 and the chiller 252. A second expansion valve 106 and an evaporator 107 are provided in the evaporator line 190. The second expansion valve 106 is provided in the evaporator line 190, selectively allowing the refrigerant to expand or bypass. The second expansion valve 106 is an electronic expansion valve (EXV) that expands the refrigerant while controlling the refrigerant flow rate.

That is, in the cooling mode, the second expansion valve 106 expands the refrigerant. In a dehumidification mode, when the engine is stopped and residual heat remains in the coolant, the second expansion valve 106 allows the refrigerant to pass through without expansion. As described above, the second expansion valve 106 selectively performs the refrigerant expansion function and the refrigerant bypass function. The evaporator 107 is arranged inside the air-conditioning case 150 to exchange heat between the refrigerant and the air, thus cooling or dehumidifying the indoor space of the vehicle.

The direction changing valve 105 is provided at a branching point between the refrigerant line 110 and the evaporator line 190 to selectively direct the refrigerant, which has passed through the intermediate heat exchanger 300, to either the chiller 252 or the evaporator 107. The direction changing valve 105 is a three-way valve and may be integrated with the second expansion valve 106 in a module type. The chiller 252 is provided upstream of the compressor 111 in the refrigerant flow direction to exchange heat between the waste heat of the second coolant line 250 and the refrigerant in the refrigerant line 110.

That is, the module-type direction changing valve 105 and the second expansion valve 106 expand the refrigerant in the cooling mode, but in the heating mode, do not expand the refrigerant and switch the direction of the refrigerant to allow the refrigerant to bypass the evaporator 107 and pass through the chiller 252. As described above, the module-type direction changing valve 105 and the second expansion valve 106 can selectively perform the refrigerant expansion function and the refrigerant direction switching function.

The evaporator 107, the heater core 205, and the indoor heat exchanger 112 are sequentially provided in the air flow direction inside an air passage of the air-conditioning case 150. A blower unit is installed near an air inflow port of the air-conditioning case 150 to blow air. The heater core 205 exchanges heat with the air passing through the heater core 205 to heat the air. A temperature door 151 is installed between the evaporator 107 and the heater core 205 to regulate the temperature of the air discharged into the indoor space of the vehicle. As the temperature door 151 rotates inside the air-conditioning case 150, the temperature door 151 controls the amount of air between a cold air passage and a warm air passage to adjust the interior temperature of the vehicle.

Meanwhile, an expansion part for expanding the refrigerant is provided in the upstream branch line 310 of the intermediate heat exchanger 300. The expansion part includes a third expansion valve 320, which is an electronic expansion valve (EXV) that selectively allows the refrigerant to expand or bypass. The intermediate heat exchanger 300 is positioned between the outdoor heat exchanger 104 and the chiller 252. That is, the intermediate heat exchanger 300 is positioned between the outdoor heat exchanger 104 and the direction changing valve 105.

The outdoor heat exchanger 104, an electric component radiator 253, and an engine radiator 202 are installed at the front of the vehicle to facilitate heat exchange with the outdoor air, and additional blower fans may be installed to ensure smooth heat exchange.

In addition, the first coolant line 211 circulates through the engine 201 and the heater core 205. The coolant circulating through the heater core 205 exchanges heat with the air, which is discharged into the indoor space of the vehicle, inside the air-conditioning case 150. The second coolant line 250 circulates through the electric components 251 and the electric component radiator 253. Furthermore, the engine 201 is connected to the engine radiator 202. A thermostat 209 and a reservoir tank 212 may be further provided in the first coolant line 211 leading to the engine radiator 202.

The coolant passing through the heater core 205 may bypass the engine 201, pass only through the engine radiator 202, and then, circulate through the heater core 205. Alternatively, the coolant passing through the heater core 205 may bypass the engine radiator 202, pass only through the engine 201, and then, circulate through the heater core 205. Alternatively, the coolant passing through the heater core 205 may pass through both the engine 201 and the engine radiator 202, and then, circulate through the heater core 205. The engine 201, water pump 207, and heater core 205 are sequentially arranged in the coolant flow direction in the first coolant line 211. The coolant passing through the engine 201 selectively flows to the engine radiator 202 or the heater core 205 through a valve.

The heat pump system for the vehicle performs heating using the engine heat of the first coolant line 211 through the heater core 205 when the engine 201 is running. Additionally, when the engine 201 is stopped, the heat pump system for the vehicle performs heating using the condensation heat of the refrigerant in the indoor heat exchanger 112 of the refrigerant line 110, while increasing the waste heat recovery of the chiller 252 through the intermediate heat exchanger 300, thereby improving heating performance.

The heat pump system for the vehicle according to the present invention is applied to a hybrid vehicle, and forms a cycle that enables heating of the indoor space even in a low-temperature environment without operating the engine 201. Accordingly, the heat pump system for the vehicle can improve fuel efficiency, reduce carbon dioxide emissions, and enhance the thermal comfort of passengers. Additionally, in conjunction with the existing internal combustion engine air conditioner (which uses the heater core), the heat pump system for the vehicle operates as a heat pump when the engine 201 is stopped, and in this case, utilizes the intermediate heat exchanger 300 to increase waste heat recovery from electric components.

The intermediate heat exchanger 300 can improve heating performance, and in the cooling mode, enhance cooling performance by further cooling the refrigerant cooled in the outdoor heat exchanger 104 and sending the cooled refrigerant to the evaporator 107.

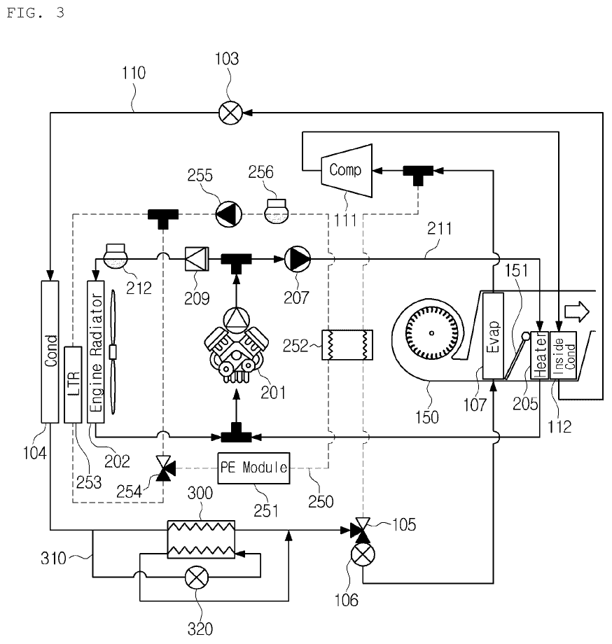

Referring to FIG. 3, in the cooling mode when the engine is operating, the refrigerant discharged from the compressor 111 passes through the indoor heat exchanger 112 without heat exchange, and bypasses the first expansion valve 103. In this case, the first expansion valve 103 remains in a full open state, allowing the refrigerant to bypass without expansion. The refrigerant passing through the first expansion valve 103 is sequentially cooled in the outdoor heat exchanger 104 and the intermediate heat exchanger 300.

Some of the refrigerant that has been primarily cooled in the outdoor heat exchanger 104 flows into the branch line 310, expands in the third expansion valve 320, and then exchanges heat with the refrigerant flowing through the intermediate heat exchanger 300. The refrigerant, which has been secondarily cooled in the intermediate heat exchanger 300, bypasses the chiller 252, passes through the direction changing valve 105, expands in the second expansion valve 106, cools the air flowing into the interior in the evaporator 107, and then circulates back to the compressor 111.

The coolant in the first coolant line 211 is cooled in the engine radiator 202. Additionally, the coolant flow in the second coolant line 250 is stopped.

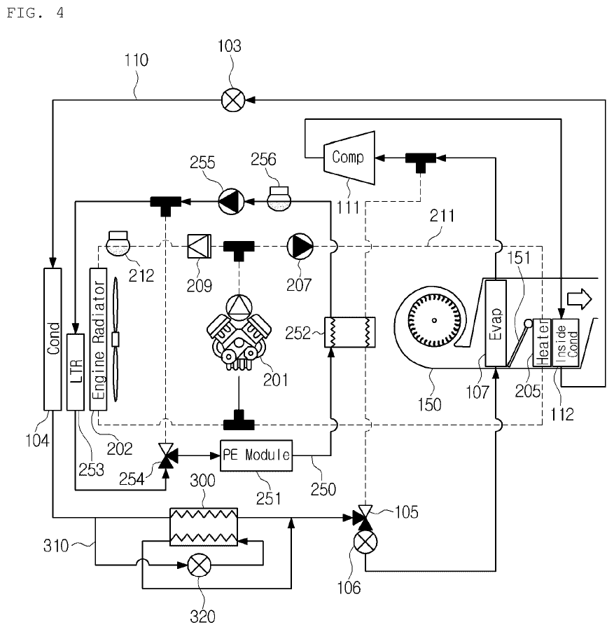

Referring to FIG. 4, in the cooling mode when the engine is stopped, the refrigerant discharged from the compressor 111 passes through the indoor heat exchanger 112 without heat exchange and bypasses the first expansion valve 103. In this case, the first expansion valve 103 remains in a full open state, allowing the refrigerant to bypass without expansion. The refrigerant passing through the first expansion valve 103 is sequentially cooled in the outdoor heat exchanger 104 and the intermediate heat exchanger 300.

Some of the refrigerant that has been primarily cooled in the outdoor heat exchanger 104 flows into the branch line 310, expands in the third expansion valve 320, and then exchanges heat with the refrigerant flowing through the intermediate heat exchanger 300. The refrigerant, which has been secondarily cooled in the intermediate heat exchanger 300, bypasses the chiller 252, passes through the direction changing valve 105, expands in the second expansion valve 106, cools the air flowing into the interior in the evaporator 107, and then circulates back to the compressor 111.

The coolant flow in the first coolant line 211 is stopped. Additionally, the coolant in the second coolant line 250 is cooled in the electric component radiator 253.

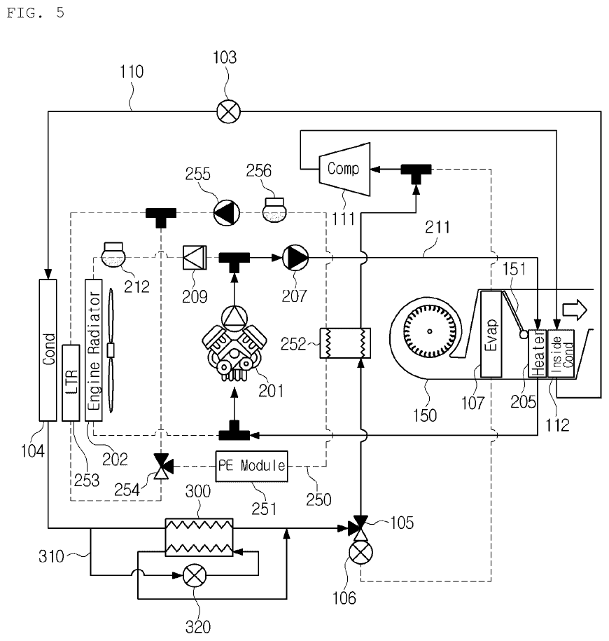

Referring to FIG. 5, in the heating mode when the engine is operating and the coolant temperature is below a reference value (relatively low temperature), the refrigerant discharged from the compressor 111 heats the air flowing into the interior in the indoor heat exchanger 112, expands in the first expansion valve 103, and then passes through the outdoor heat exchanger 104 and the intermediate heat exchanger 300. Thereafter, the refrigerant bypasses the evaporator 107 through the direction changing valve 105, passes through the chiller 252, and then circulates back to the compressor 111.

The coolant in the first coolant line 211 circulates through the heater core 205, heating the air flowing into the interior. Additionally, the coolant flow in the second coolant line 250 is stopped.

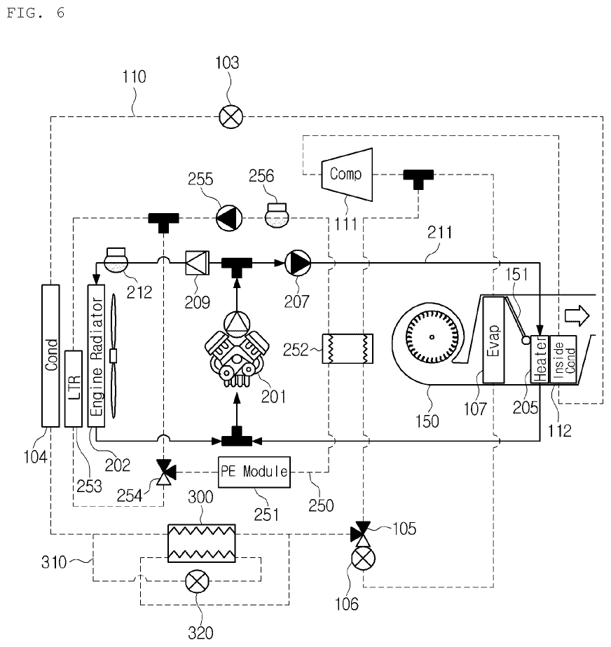

Referring to FIG. 6, in the heating mode when the engine is operating and the coolant temperature exceeds the reference value (relatively high temperature), the refrigerant flow in the refrigerant line 110 is stopped. The coolant in the first coolant line 211 circulates through the heater core 205, heating the air flowing into the interior. Additionally, the coolant flow in the second coolant line 250 is stopped.

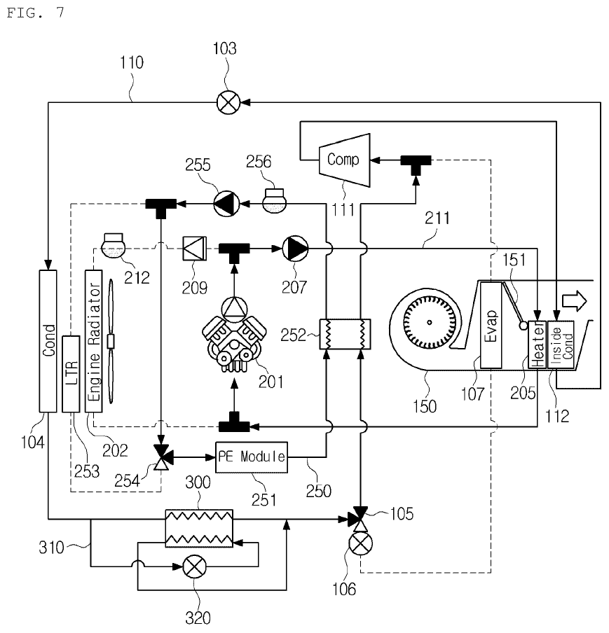

Referring to FIG. 7, in the heating mode when the engine is stopped and the coolant temperature exceeds the reference value (residual heat in the coolant exists), the refrigerant discharged from the compressor 111 heats the air flowing into the indoor space in the indoor heat exchanger 112, expands in the first expansion valve 103, and then passes through the outdoor heat exchanger 104 and the intermediate heat exchanger 300. The refrigerant, which has been further cooled by the refrigerant expanded by the third expansion valve 320 of the branch line 310 in the intermediate heat exchanger 300, bypasses the evaporator 107 through the direction changing valve 105, passes through the chiller 252, and then circulates back to the compressor 111.

The refrigerant exchanges heat with the coolant of the second coolant line 250 in the chiller 252 to absorb the waste heat from the electric components 251. The coolant in the first coolant line 211 circulates through the heater core 205 to heat the air flowing into the interior. Furthermore, the coolant in the second coolant line 250 is cooled in the chiller 252.

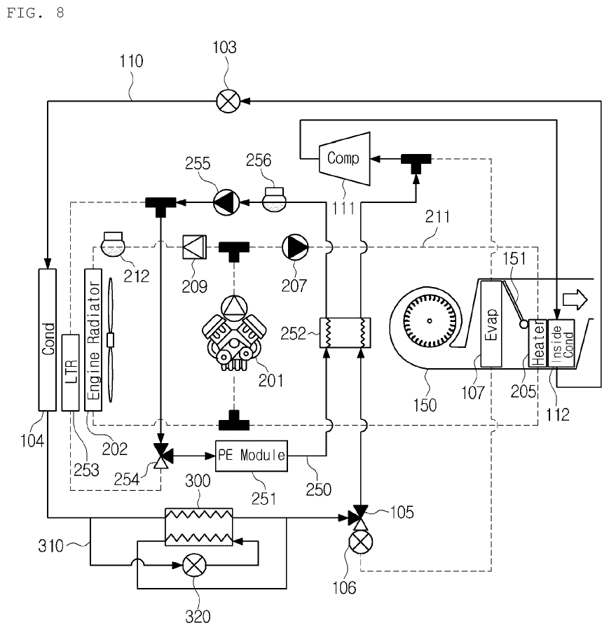

Referring to FIG. 8, in the heating mode when the engine is stopped and the coolant temperature is below the reference value (relatively low temperature), the refrigerant discharged from the compressor 111 heats the air flowing into the indoor space in the indoor heat exchanger 112, expands in the first expansion valve 103, and then passes through the outdoor heat exchanger 104 and the intermediate heat exchanger 300. The refrigerant, which has been further cooled by the refrigerant expanded by the third expansion valve 320 of the branch line 310 in the intermediate heat exchanger 300, bypasses the evaporator 107 through the direction changing valve 105, passes through the chiller 252, and then circulates back to the compressor 111.

The refrigerant exchanges heat with the coolant of the second coolant line 250 in the chiller 252 to absorb the waste heat from the electric components 251. The coolant flow in the first coolant line 211 is stopped. In addition, the coolant in the second coolant line 250 is cooled in the chiller 252.

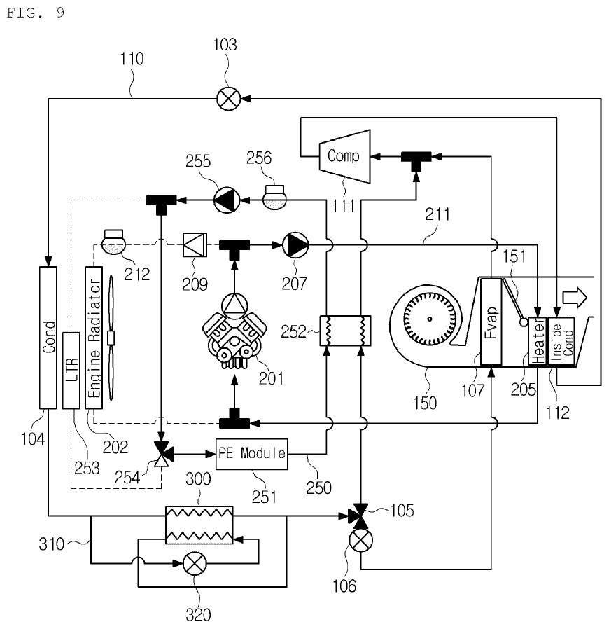

Referring to FIG. 9, in the dehumidification mode when the engine is stopped and the coolant temperature exceeds the reference value (residual heat in the coolant exists), the refrigerant discharged from the compressor 111 heats the air flowing into the interior in the indoor heat exchanger 112, expands in the first expansion valve 103, and then passes through the outdoor heat exchanger 104 and the intermediate heat exchanger 300. Some of the refrigerant passing through the intermediate heat exchanger 300 passes through the chiller 252, and the rest of the refrigerant passes through the evaporator 107 and circulates back to the compressor 111.

Additionally, the coolant in the first coolant line 211 circulates through the heater core 205 to heat the air flowing into the interior. The coolant in the second coolant line 250 is cooled in the chiller 252.

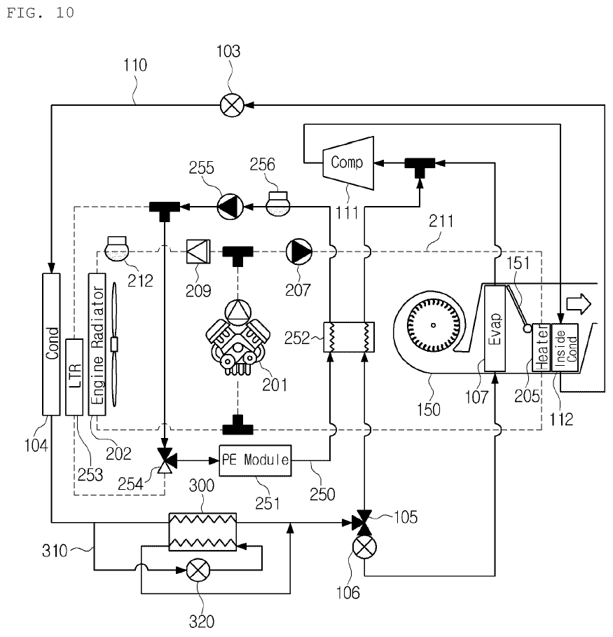

Referring to FIG. 10, in the dehumidification mode when the engine is stopped and the coolant temperature is below the reference value (relatively low temperature), the refrigerant discharged from the compressor 111 heats the air flowing into the indoor space in the indoor heat exchanger 112, expands in the first expansion valve 103, and then passes through the outdoor heat exchanger 104 and the intermediate heat exchanger 300. Some of the refrigerant passing through the intermediate heat exchanger 300 passes through the chiller 252, and the rest of the refrigerant passes through the evaporator 107 and circulates back to the compressor 111.

The coolant flow in the first coolant line 211 is stopped. In addition, the coolant in the second coolant line 250 is cooled in the chiller 252.

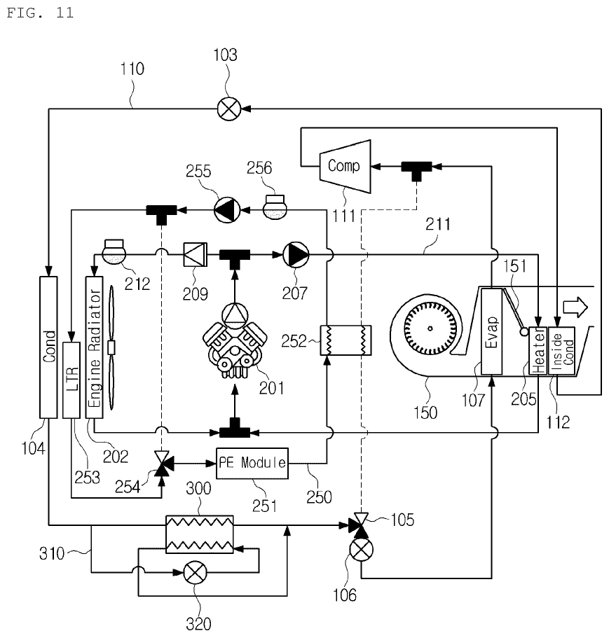

Referring to FIG. 11, in the dehumidification mode when the engine is operating and the coolant temperature exceeds the reference value (relatively high temperature), the refrigerant discharged from the compressor 111 is primarily cooled in the outdoor heat exchanger 104, is secondarily cooled in the intermediate heat exchanger 300, bypasses the chiller 252, expands in the second expansion valve 106 to dehumidify the air flowing into the interior in the evaporator 107, and then circulates back to the compressor 111.

The coolant in the first coolant line 211 circulates through the heater core 205 to heat the air flowing into the indoor space. Additionally, the coolant in the second coolant line 250 is cooled in the electric component radiator 253.

The heat pump system for a vehicle according to the present invention can heat the indoor space under a low-temperature environment without operating the engine, improve fuel efficiency, reduce the emission of carbon dioxide, and improve the comfort of passengers by applying the heat pump system to a hybrid vehicle. Moreover, the heat pump system is configured to work in conjunction with a conventional air conditioner using a heater core, and performs heating using coolant when the engine is operated, thus effectively heating the indoor space even in extremely low temperatures of −30° C.

Furthermore, in the cooling mode, the heat pump system utilizes the intermediate heat exchanger to further expand the refrigerant, thereby improving cooling efficiency and enhancing cooling performance. Additionally, in the heat pump mode, the heat pump system cools the hot refrigerant discharged from the compressor in the indoor heat exchanger and further cools in the intermediate heat exchanger to exchange heat between the cooled refrigerant and the waste heat of the electric component in the chiller, thereby facilitating efficient heat recovery and improving heat pump efficiency.

In addition, even when the engine is turned off during the operation in the heat pump mode, the heat pump system makes the most of the residual heat of the coolant due to the operation of the existing engine to perform heating. If the coolant temperature is below approximately 40° C. (which may vary depending on the outdoor temperature), the heat pump system can smoothly perform linking between heat sources without boundary layers due to the operation of the heat pump utilizing electric component waste heat, further enhancing the comfort of passengers.

In the heating mode, heat recovery is achieved in the indoor heat exchanger (condenser), but if frost forms on the outdoor heat exchanger, the heat pump system for the vehicle according to the present invention can improve the heating efficiency and performance through the configuration that recovers waste heat from electric components through the chiller. In addition, the heat pump system for the vehicle according to the present invention can improve the cooling performance in the cooling mode by exchanging heat between inlet refrigerant and outlet refrigerant through the intermediate heat exchanger, which further cools the refrigerant midway, and in the heating mode, can improve the heating performance by facilitates waste heat recovery.

While the heat pump system for the vehicle of the present invention has been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

1. A heat pump system for a vehicle, comprising:
a refrigerant line which circulates refrigerant discharged from a compressor to cool or heat the indoor space of the vehicle;
a first coolant line which circulates an engine and a heater core arranged inside an air-conditioning case; and
a second coolant line which circulates electric components and an electric component radiator,
wherein a chiller is provided to exchange heat between the waste heat of the second coolant line and the refrigerant, and wherein an intermediate heat exchanger is provided in an upstream refrigerant line of the chiller to exchange heat with the expanded refrigerant, cooling the refrigerant passing through the intermediate heat exchanger.

2. The heat pump system according to claim 1, wherein an outdoor heat exchanger is provided in a downstream refrigerant line of the compressor to exchange heat between the refrigerant and outdoor air, and
wherein the intermediate heat exchanger is arranged between the outdoor heat exchanger and the chiller.

3. The heat pump system according to claim 1, wherein a branch line which branches from an upstream refrigerant line of the intermediate heat exchanger and merges into the downstream side thereof is provided,
wherein the intermediate heat exchanger exchanges heat between the refrigerant in the branch line and the refrigerant in the refrigerant line, and
wherein an expansion part for expanding the refrigerant is provided in the upstream branch line of the intermediate heat exchanger.

4. The heat pump system according to claim 2, wherein the compressor, an indoor heat exchanger arranged inside the air-conditioning case, the outdoor heat exchanger, the intermediate heat exchanger, and the chiller are sequentially provided in the refrigerant line, and
wherein an evaporator line branches from the refrigerant line between the intermediate heat exchanger and the chiller, and an evaporator arranged inside the air-conditioning case is provided in the evaporator line.

5. The heat pump system according to claim 4, wherein a direction changing valve is provided at a branching point between the refrigerant line and the evaporator line to selectively direct the refrigerant, which has passed through the intermediate heat exchanger, to either the chiller or the evaporator.

6. The heat pump system according to claim 4, further comprising:
a first expansion valve provided between the indoor heat exchanger and the outdoor heat exchanger to expand the refrigerant; and
a second expansion valve provided in the evaporator line to expand the refrigerant.

7. The heat pump system according to claim 6, wherein the first expansion valve and the second expansion valve are configured to selectively allow the refrigerant to expand or bypass.

8. The heat pump system according to claim 1, wherein heating is performed using engine heat of the first coolant line through the heater core when the engine is running, and heating is performed using condensation heat of the refrigerant in the refrigerant line when the engine is stopped, with the waste heat recovery of the chiller increased through the intermediate heat exchanger.

9. The heat pump system according to claim 6, wherein in a cooling mode, when the engine is operating, the refrigerant discharged from the compressor is primarily cooled in the outdoor heat exchanger, is secondarily cooled in the intermediate heat exchanger, bypasses the chiller, expands in the second expansion valve to cool the air flowing into the indoor space in the evaporator, and circulates back to the compressor,
wherein the coolant in the first coolant line is cooled in an engine radiator, and
wherein the coolant flow in the second coolant line is stopped.

10. The heat pump system according to claim 6, wherein in a cooling mode, when the engine is stopped, the refrigerant discharged from the compressor is primarily cooled in the outdoor heat exchanger, is secondarily cooled in the intermediate heat exchanger, bypasses the chiller, expands in the second expansion valve to cool the air flowing into the indoor space in the evaporator, and circulates back to the compressor,
wherein the coolant flow in the first coolant line is stopped, and
wherein the coolant in the second coolant line is cooled in the electric component radiator.

11. The heat pump system according to claim 6, wherein in a heating mode, when the engine is operating and the coolant temperature is below a reference value, the refrigerant discharged from the compressor heats the air flowing into the indoor space in the indoor heat exchanger, expands in the first expansion valve, passes through the outdoor heat exchanger, the intermediate heat exchanger, and the chiller, and then, circulates back to the compressor,
wherein the coolant in the first coolant line circulates through the heater core to heat the air flowing into the interior, and
wherein the coolant flow in the second coolant line is stopped.

12. The heat pump system according to claim 6, wherein in a heating mode, when the engine is operating and the coolant temperature exceeds the reference value, the refrigerant flow in the refrigerant line is stopped,
wherein the coolant in the first coolant line circulates through the heater core to heat the air flowing into the interior, and
wherein the coolant flow in the second coolant line is stopped.

13. The heat pump system according to claim 6, wherein in a heating mode, when the engine is stopped and the coolant temperature exceeds the reference value, the refrigerant discharged from the compressor heats the air flowing into the interior in the indoor heat exchanger, expands in the first expansion valve, and passes through the outdoor heat exchanger and the intermediate heat exchanger, and the refrigerant, which has been further cooled in the intermediate heat exchanger, exchanges heat with the coolant of the second coolant line in the chiller, and then circulates back to the compressor,
wherein the coolant in the first coolant line circulates through the heater core to heat the air flowing into the interior, and
wherein the coolant in the second coolant line is cooled in the chiller.

14. The heat pump system according to claim 6, wherein in a heating mode, when the engine is stopped and the coolant temperature is below the reference value, the refrigerant discharged from the compressor heats the air flowing into the interior in the indoor heat exchanger, expands in the first expansion valve, and passes through the outdoor heat exchanger and the intermediate heat exchanger, and the refrigerant, which has been further cooled in the intermediate heat exchanger, exchanges heat with the coolant of the second coolant line in the chiller, and then circulates back to the compressor,
wherein the coolant flow in the first coolant line is stopped, and
wherein the coolant in the second coolant line is cooled in the chiller.

15. The heat pump system according to claim 6, wherein in a dehumidification mode, when the engine is stopped and the coolant temperature exceeds the reference value, the refrigerant discharged from the compressor heats the air flowing into the interior in the indoor heat exchanger, expands in the first expansion valve, passes through the outdoor heat exchanger and the intermediate heat exchanger, and circulates back to the compressor in such a way that some of the refrigerant passes through the chiller and the rest of the refrigerant passes through the evaporator,
wherein the coolant in the first coolant line circulates through the heater core to heat the air flowing into the interior, and
wherein the coolant in the second coolant line is cooled in the chiller.

16. The heat pump system according to claim 6, wherein in a dehumidification mode, when the engine is stopped and the coolant temperature is below the reference value, the refrigerant discharged from the compressor heats the air flowing into the interior in the indoor heat exchanger, expands in the first expansion valve, passes through the outdoor heat exchanger and the intermediate heat exchanger, and circulates back to the compressor in such a way that some of the refrigerant passes through the chiller and the rest of the refrigerant passes through the evaporator,
wherein the coolant flow in the first coolant line is stopped, and
wherein the coolant in the second coolant line is cooled in the chiller.

17. The heat pump system according to claim 6, wherein in a dehumidification mode, when the engine is operating and the coolant temperature exceeds the reference value, the refrigerant discharged from the compressor is primarily cooled in the outdoor heat exchanger, is secondarily cooled in the intermediate heat exchanger, bypasses the chiller, expands in the second expansion valve to dehumidify the air flowing into the indoor space in the evaporator, and circulates back to the compressor,
wherein the coolant in the first coolant line circulates through the heater core to heat the air flowing into the interior, and
wherein the coolant in the second coolant line is cooled in the electric component radiator.
